(19) United States
(12) Patent Application Publication
(10) Pub. No.: US 2003/0208376 A1
(43) Pub. Date: Nov. 6, 2003

(54) System and method for disseminating nutritional information

(76) Inventors: Eileen Vennum, Westfield Grand Prairie, TX (US); Bill McAnalley, Grand Prairie, TX (US); Cindy Tysinger, Coppell, TX (US)

Correspondence Address: HAYNES AND BOONE, LLP, 901 MAIN STREET, SUITE 3100, DALLAS, TX, 75202, US

(21) Appl. No.: 10/220,748

(22) PCT Filed: Mar. 2, 2001
(86) PCT No.: PCT/US01/06635

(51) Int. Cl. G06F 17/60

(52) U.S. Cl. 705/2

(57) ABSTRACT

A method and system for the online dissemination of dietary nutritional information includes providing an Internet host station (12) with at least one database that is connectable via the Internet to a remote station (14) via an Internet connection (15). The host station (12) includes a plurality of documents (20, 22, 24, 26) relating to health and nutrition information, including information relating to numerous natural dietary products and ingredients. Publications (30, 32, 34) cited by the documents can be quickly accessed by hyperlinked reference numerals for ascertaining the accuracy and legitimacy of the documents to thereby increase the confidence of consumers and medical professionals with respect to the health benefits associated with dietary products and ingredients.

### BACKGROUND OF THE INVENTION

1. Field of the Invention

This invention relates generally to a system and method for disseminating information, and more particularly to an online system and method for disseminating nutritional and health information relating to the safety, effectiveness and research of products and ingredients that may fall outside the realm of government regulating agencies.

2. Description of the Related Art

Passage of the U.S. Dietary Supplement Health and Education Act (DSHEA) in 1994 granted new freedoms to distributors in the area of information that can be made available to consumers in connection with the sale of a product, such as dietary supplements. The DSHEA not only allows but encourages companies to responsibly provide truthful and balanced educational materials about their products to potential customers. Educational materials that meet the standards of DSHEA are termed “labeling-exempt.” That is, such materials are exempt from review by the U.S. Food and Drug Administration (FDA) as labeling or promotional materials. These non-promotional, educational materials may contain research information about potential effects of dietary supplements on disease conditions. As set forth in DSHEA, it was the intent of Congress to improve the health of persons through improved product choices made by informed consumers. Congress believed that this, in turn, would lower healthcare costs for the nation.

Despite the availability of educational materials regarding dietary supplements, it is often difficult for a person, such as a consumer, medical professional, retail vendor, or researcher to locate that information at a centralized location. Even when the desired information regarding dietary supplements is provided, many consumers and medical professionals are wary of the reliability of such information since it is provided by the manufacturer or distributor. Hence, the consumer may be hesitant to purchase a product, and the medical professional may be hesitant to recommend a product that may be beneficial to a person's health or well-being. This problem is further augmented by companies that may hold proprietary rights to one or more products, and therefore may be the best source of information for the products.

The inability to verify the accuracy of information relating to dietary supplements may cause hesitancy among consumers for purchasing and using such products, as well as hesitancy among medical professionals for recommending such products.

### SUMMARY OF THE INVENTION

It is therefore an object of the present invention to provide a system and method for disseminating information regarding dietary supplements.

It is a further object of the invention to provide a system and method for verifying the accuracy of the disseminated information.

It is an even further object of the invention to provide online information regarding dietary supplements and ingredients, and verifying that information by referring to research conducted by disinterested third parties, and making such research available to consumers, medical professionals, and researchers at a centralized location.

According to one embodiment of the invention, a method for online dissemination of nutritional information comprises providing a host station that has at least one document with information relating to the nutritional information. The document includes at least one reference citation hyperlinked to at least one publication located at a medical information station. Preferably, the at least one publication is prepared by a disinterested third party. A connection is made between the host station and a remote station. The at least one document is located and the reference citation is selected in the document for hyperlinking to the at least one publication at the medical information station. In this manner, information in the at least one document can be verified by reviewing the at least one publication.

According to a further embodiment of the invention, a system for online dissemination of nutritional information comprises a host station and a medical information station. The host station includes at least one document with information relating to the nutritional information and at least one reference citation. The medical information station includes at least one publication. The at least one citation is hyperlinked to the at least one publication. With this arrangement, information in the at least one document can be verified by hyperlinking to the at least one publication at the medical information station.

### BRIEF DESCRIPTION OF THE DRAWINGS

The preferred embodiments of the present invention will hereinafter be described in conjunction with the appended drawings, wherein like designations denote like elements, and further wherein:

FIG. 1 is a schematic representation of an interactive system for disseminating nutritional information according to the invention;

FIG. 2 depicts a representative introductory display screen according to the invention;

FIG. 3 depicts a representative general nutrition information display screen according to the invention;

FIG. 4 shows the general information display screen of FIG. 3 together with a bibliographic display screen;

FIG. 5 depicts a representative reference information display screen that can be accessed from the bibliographic display screen;

FIG. 6 depicts a representative search display screen for locating ingredients according to the invention;

FIG. 7 shows a representative ingredients display screen that can be accessed from the search display screen of FIG. 6;

FIG. 8 shows a representative ingredients information display screen that can be accessed by the ingredients display screen of FIG. 7; and

FIG. 9 shows the ingredients information display screen of FIG. 8 together with a bibliographic display screen.

It is noted that the accompanying drawings are intended to depict only typical embodiments of the invention and should not be considered as limiting the scope thereof. The invention will now be described in greater detail with reference to the accompanying drawings.

### DETAILED DESCRIPTION OF THE PREFERRED EMBODIMENTS

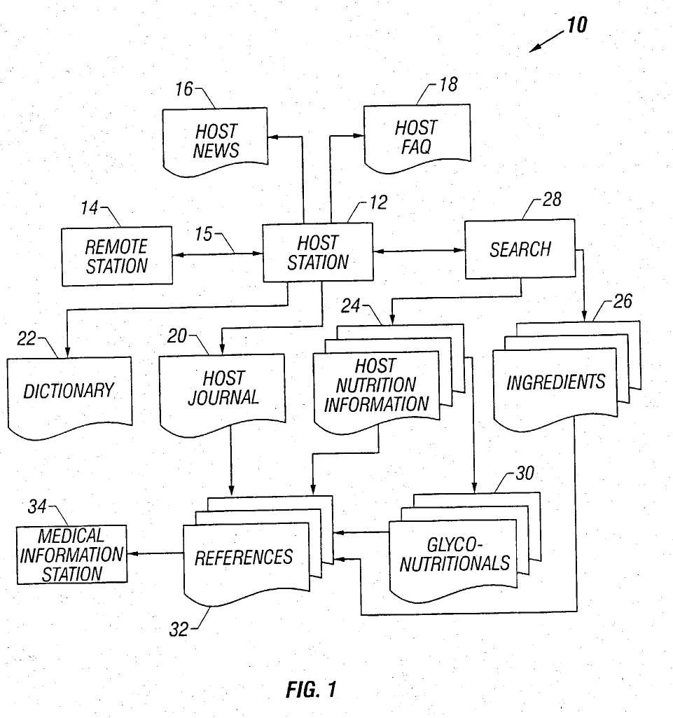

Referring now to the drawings, and to FIG. 1 in particular, a system 10 for disseminating information relating to health, nutrition and research is illustrated. The system 10 includes a host station 12 adapted for connection between a plurality of remote stations 14 (only one of which is shown).

In one exemplary embodiment, the host station 12 is an Internet domain site and each remote station 14 includes a personal computer that is connectable to the Internet through a connection 15 in a well-known manner. Alternatively, the host station 12 may be in the form of one or more portable memory devices, such as CD-ROM's, DVD's, floppy disks, flash cards, or other memory devices currently in use or that may be developed in the future that connects to the user station through a connector cable or other well known connection means. Likewise, the remote station may alternatively be in the form of an interactive television device, a display telephone, or any other interactive display currently in use or that may be developed in the future. Whether the host station is an Internet site, a portable memory device, or other suitable systems or components, information relating to health, nutrition and research can be selectively downloaded and displayed on the remote stations, as will be described in greater detail below.

The remote station 14 preferably includes, but is not limited to any individual, medical professional, medical office, hospital, group, partnership, company, corporation, manufacturer, university, research and development facility, government agency, and/or any other entity that desires to obtain information relating to health and nutrition, whether or not such information is used to purchase or recommend a product based on the information.

The host station 12 has information item modules that may include, but are not limited to a news module 16, a Frequently Asked Questions (FAQ) module 18, a publication module 20, a dictionary module 22, a product information module 24, and an ingredients module 26. A module, as used herein, may refer to one or more lines of code, one or more files of information, and/or one or more web pages.

The news module 16 may include, but is not limited to information relating to current events, discoveries, research, intellectual property rights or grants, nutritional glycoscience and related issues of nutrition and health, dietary supplements and other products, and so on. The news module 16 may also enable access to archived news stories.

The FAQ module 18 may include, but is not limited to questions and answers about the host station, dietary supplements in general, government regulations, safety information, dosage information for dietary supplements and ingredients, and so on.

The journal module 20 preferably includes one or more articles relating to dietary supplements, ingredients, current research, discoveries, and so on, that may be prepared by the host station or third parties and not included in the news module 16.

The glyco-nutritional information module 24 may include information relating specifically to glyco-nutritionals 30, including a general description, disease-specific reviews, and saccharide-specific reviews.

The ingredients module 26 preferably includes information relating to natural ingredients that may be used either alone or in combination with other ingredients to obtain a desired health benefit. The information associated with each ingredient may include health benefits, side-effects, recommended dosage levels, adverse medications or other products to avoid while taking the ingredient, history of development and use, and soon.

The dictionary module 22 may include information from one or more standard dictionaries, medical dictionaries, technology-specific dictionaries, and the like, with definitions for one or more words that may be located in any of the other modules. The dictionary module 22 is accessed when a word in a document is selected by a user at the remote station. Preferably, the word to be defined is highlighted or otherwise distinguishable over other words.

A references module 32 is accessible by the journal module 20, the product information module 24, the glyco-nutritional module 30, and the ingredients module 26. In this manner, information associated with each module that may include one or more references to articles, research papers, and the like, may be directly accessed through hyperlinks.

A search engine 28 is also provided at the host station 12 and is preferably capable of searching products and ingredients, as well as words that may be associated with any document or module stored at the host station. In this manner, documents or modules relating to one or more words representing a particular subject matter or area of interest may be located and retrieved.

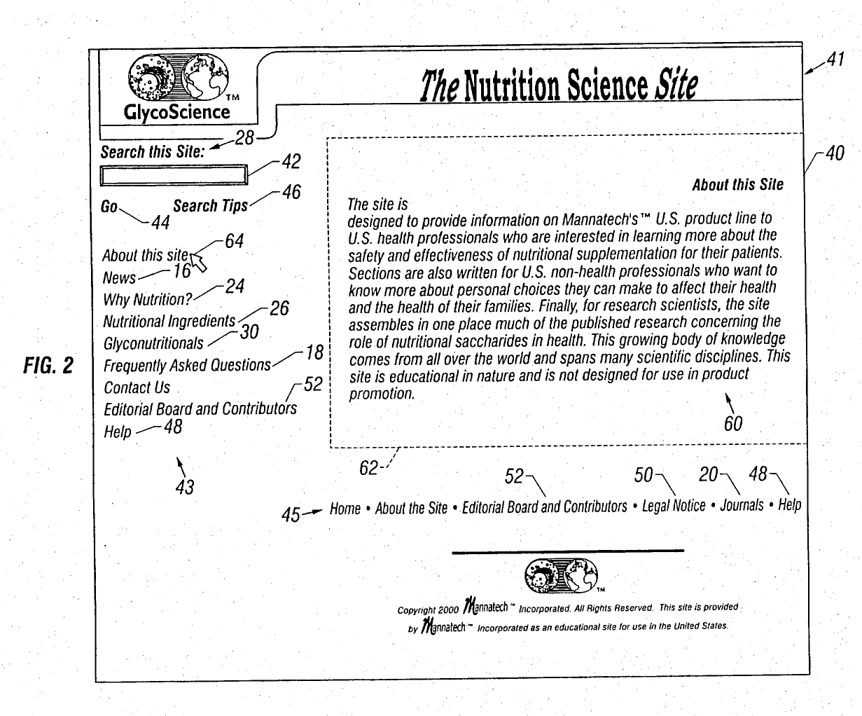

With reference now to FIG. 2, the modules and the search engine 28 are preferably accessible from an introductory menu screen 40. As shown, each of the modules 16, 18, 20, 24, 26, and 30 are represented as menu items on side and bottom menu bars 43 and 45, respectively. In turn, the menu items are hyperlinked to one or more address sites. Preferably, the menu items are hyperlinked to one or more Web pages of the host station. The menu screen 40 also includes a title bar 41 that may be displayed on each of the Web pages.

The search engine 28 includes a universal search box 42 for entering one or more search terms, a “Go” icon 44 for initiating the search once the search term(s) is/are entered in the box 42, and a “Search Tips” icon 46 that hyperlinks to a help screen (not shown) that gives examples and instructions on conducting searches. Preferably, the search engine 28 is searchable with Boolean terms and is available on all Web pages of the host station with the exception of documents that are displayed in special printing format, as will be described in greater detail below.

The menu screen 40 may include other hyperlinks to other modules, such as a help module 48, a legal notices module 50, an editorial board and article contributors module 52, and so on.

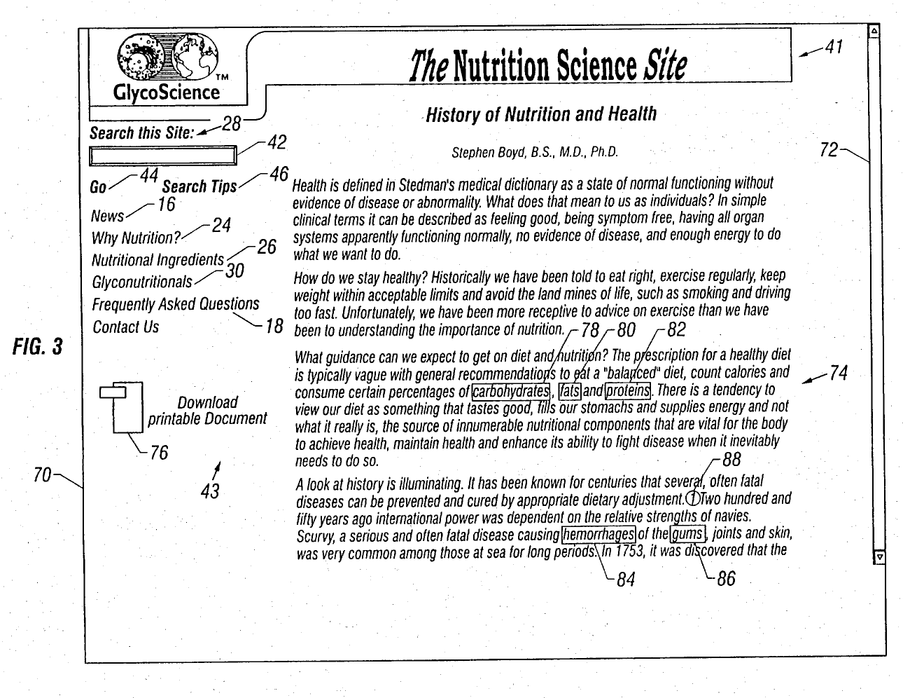

With further reference to FIGS. 3 to 9, a method for electronically accessing information on the system 10 will now be described. The method together with the system 10 may be implemented in hardware, software, or a suitable combination of hardware and software, and may be more than one software system operating on a general purpose user computing platform. As used herein, a software system may be implemented as one or more separate lines of code of a software program, one or more subroutines, one or more agents, one or more objects, one or more lines of code operating on different computer platforms, or other suitable software functionality. For example, a software system may include functionality that is provided by the operating system of the computing platform, plus other application-specific functionality.

The method according to an exemplary embodiment of the invention begins by accessing the introductory menu screen 40 at the host station 12 by the remote station 14. Preferably, the host station is accessed through an Internet connection and an Internet Service Provider (ISP) by one or more remote stations. Alternatively, where the host station 12 is in the form of one or more portable memory devices, one or more files of the host station may be accessed from the portable memory device.

The position of a cursor 64 on the menu screen 40 is controlled by a user at the remote station 14 through an input device (not shown) such as a mouse or pointing stick. When the cursor 64 is aligned with one of the module hyperlinks without pressing a selection button associated with the input device, a brief description 60 of that module appears in a screen area 62 (shown in dashed line) of the introductory menu screen 40. The contents of the screen area 62 will change in the menu screen 40 as the cursor 64 is moved from one menu item to another. Thus, a user unfamiliar with the contents and features of the host station may obtain an overall view of the host station without actually hyperlinking to the information modules.

When a particular module is selected by pressing a button or other user interface associated with the input device, an information display screen associated with the selected module will appear on a display device (not shown) at the remote station 14. By way of example, when the nutrition information module 24 is selected, an information display screen 70 (FIG. 3) appears. The information display screen 70 may include one or more documents 74 relating to general nutrition and health. A scroll bar 72 may provided for viewing the entire document. An icon 76 may be selected by the remote station 14 for viewing and printing the document(s) in a predefined format, so that extraneous items associated with the information screen, such as the title bar and menu items bar will not be included. Preferably, selection of the icon 76 displays the document in PDF or similar format in a pop-up or floating window. Alternatively, the document may be hyperlinked to a separate Internet site or Web page.

As shown, the document 74 includes highlighted words 78, 80, 82, 84 and 86 that are hyperlinked to the dictionary module 22 (FIG. 1). Selection of a highlighted word preferably displays a pop-up or floating window (not shown) that shows the selected word and it's definition. A reference of the particular dictionary used to generate the definition may also be displayed in the pop-up window. Although not shown in FIG. 3, other words relating to dietary ingredients may also be highlighted and hyperlinked to a pop-up window or information screen where information relating to the selected ingredient may be displayed. The ingredient words can be visually distinguishable over the words with definitions.

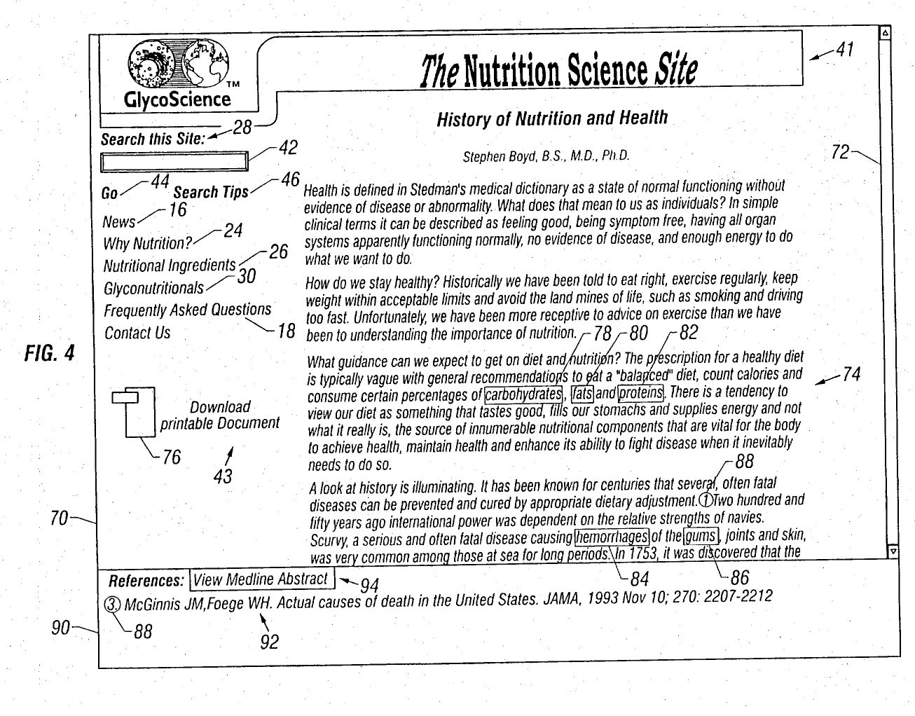

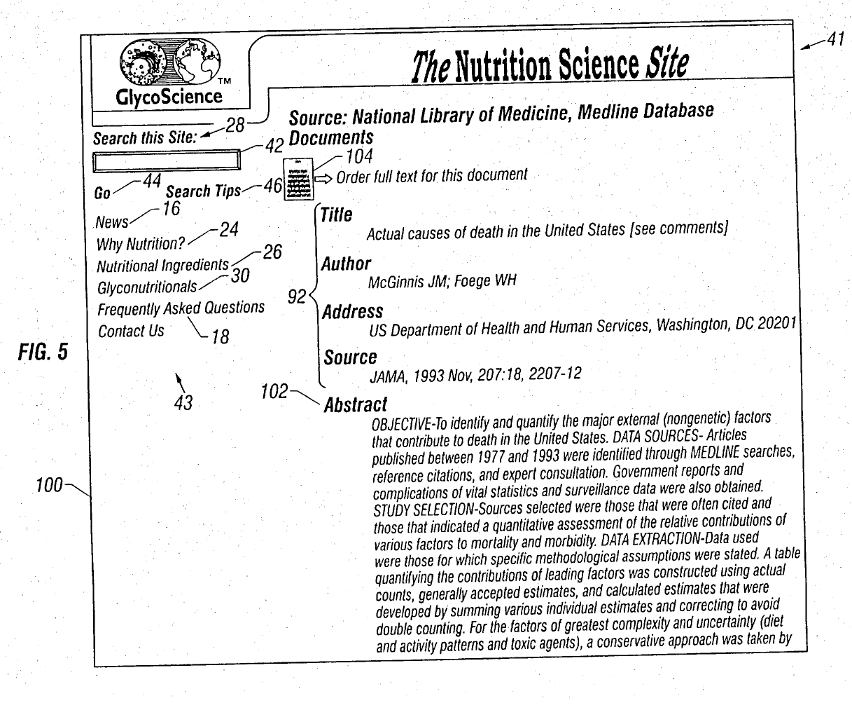

With particular reference FIGS. 3 to 5, the document 74 may also include one or more reference numerals 88 that hyperlink to the references module 32 (FIG. 1). The numerals 88 refer to publications such as articles, research papers, and the like that relate to the subject matter being discussed in the document 74. Selection of a reference numeral 88 invokes a window 90 (FIG. 4) that is displayed with the information screen 70. The window 90 displays the selected reference numeral 88 along with bibliographic information 92 of the referenced publication. An indicator 80 is also provided in the window 90 for indicating whether the referenced publication is available online. Preferably, the indicator 94 is hyperlinked to a reference information display screen 100 (FIG. 5) when the publication is available online.

The reference information display screen 100 includes the bibliographic information 92 and an abstract 102 of the referenced publication. An icon 104 is also provided for ordering the full text of the publication. Preferably, the icon 104 is hyperlinked to a medical information station 34 (FIG. 1), which preferably is a disinterested third party Internet site containing published papers in all areas of medicine, including health and nutrition. A suitable Internet site is known as the Medline Database provided by the National Library of Medicine. Selection of the icon 104 brings the user to the appropriate location of the medical information station 34 for downloading the publication to the remote station 14.

When the referenced publication is unavailable online, the indicator 94 does not include a hyperlink. If desired, an icon or hyperlink may be provided (not shown) for invoking a search of publications similar to the referenced publication.

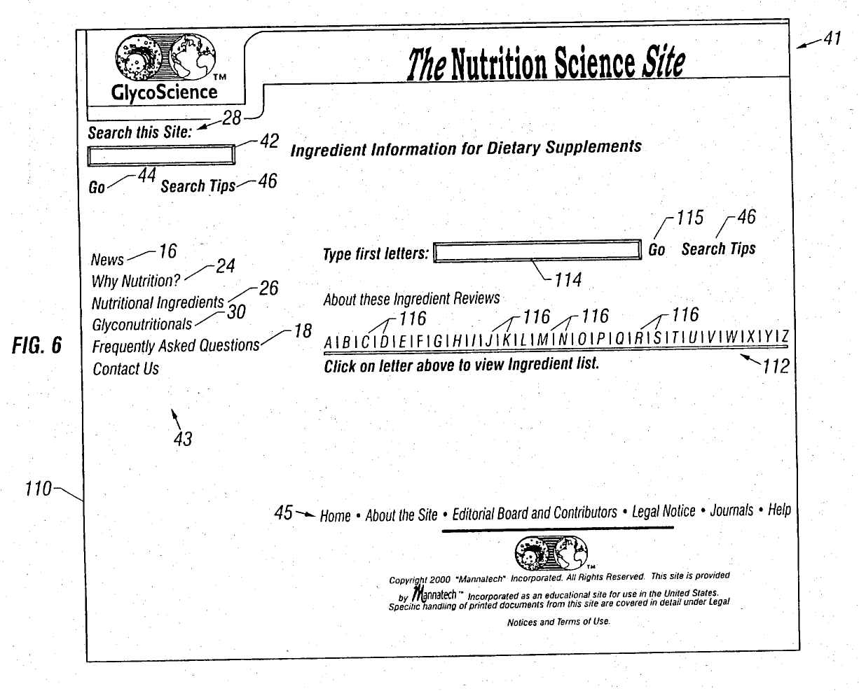

With particular reference now to FIG. 6, selection of the hyperlink related to the nutritional ingredients module 26 brings the user to a search display screen 110. The search display screen 110 includes the title bar 41, universal search box 42, menu bars 43 and 45, together with an alphabetical icon bar 112 and an ingredient search box 114. Ingredient-specific letters and words can be entered into the search box 114 and a search can be initiated by pressing the “Go” icon 115 associated with the box 114. Results of the search can then be displayed on a search results display screen (not shown).

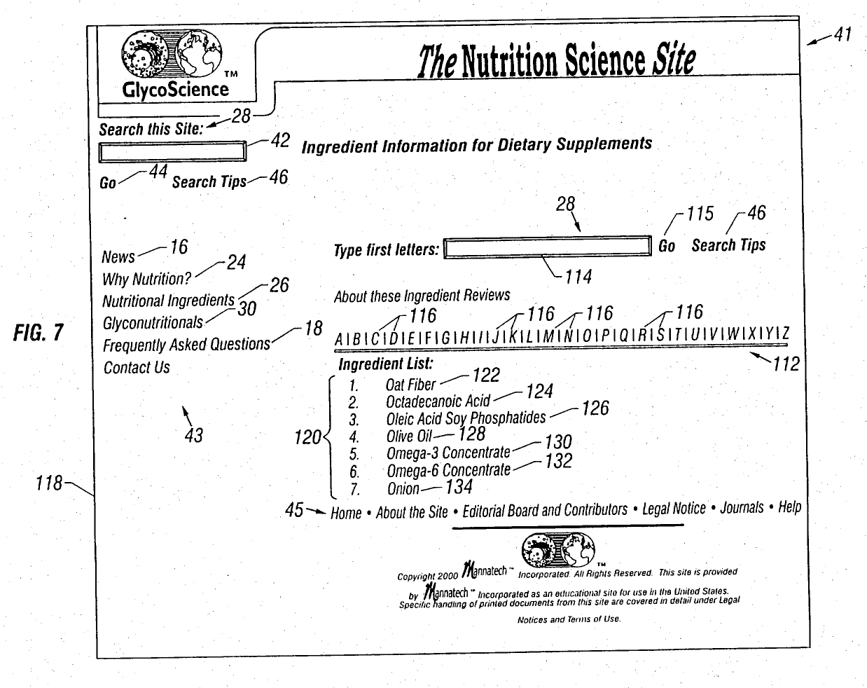

As shown in FIGS. 6 and 7, the icon bar 112 includes letters 116 from A to Z that are each hyperlinked to a different ingredient screen 118 (FIG. 7). Each ingredient display screen 118 provides a list 120 of ingredients having the same letter as the selected letter 116. By way of example, selection of the letter “O” in the icon bar 112 brings the user to the ingredient display screen 118 with a list 120 of ingredients that begin with the letter “O”. As illustrated in FIG. 7, the list 120 includes Oat Fiber 122, Octadecanoic Acid 124, Oleic Acid Soy Phosphatides 126, Olive Oil 128, Omega-3 Concentrate 130, Omega-6 Concentrate 132, and Onion 134. It is to be understood that the illustrated list 120 is not necessarily exhaustive, and may contain more or less ingredients. Preferably, each ingredient 122-134 is hyperlinked to an ingredient information display screen that provides detailed information of the selected ingredient.

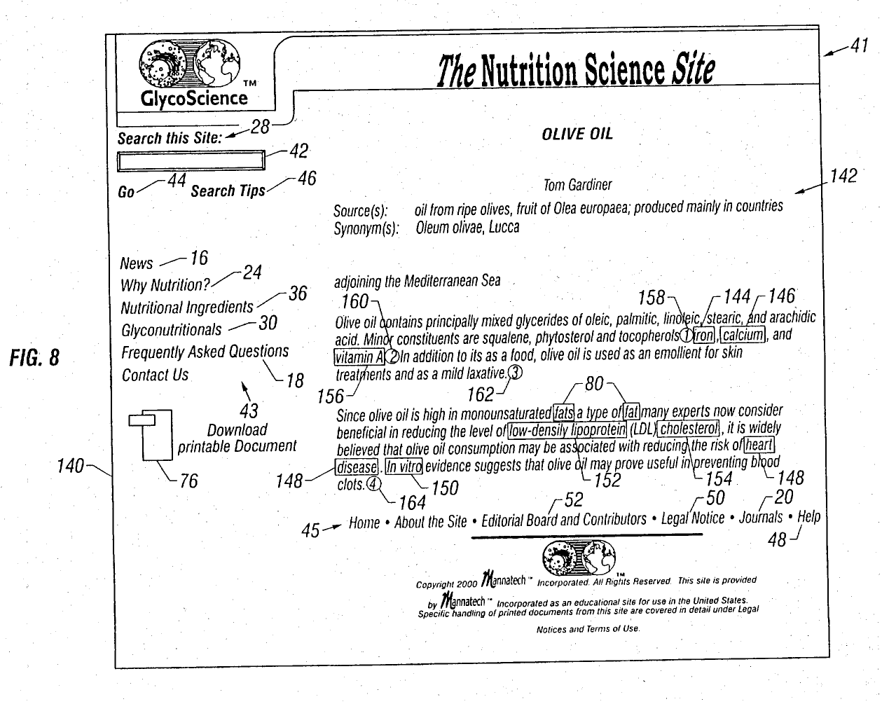

By way of example, and with further reference to FIG. 8, selection of the Olive Oil hyperlink 128 brings the user to an ingredient information display screen 140 which includes one or more documents 142 relating to the selected ingredient, in this case olive oil. A scroll bar (not shown) may provided for viewing the entire document if necessary. An icon 76 may be selected by the remote station 14 for viewing and printing the ingredient information document(s) in a predefined format, so that extraneous items associated with the ingredient information screen 140, such as the title bar 41 and menu items bars 43 and 45 will not be included. Preferably, selection of the icon 76 displays the document in PDF or similar format in a pop-up or floating window. Alternatively, the document may be hyperlinked to a separate Internet site or Web page.

As shown, the document 142 is similar to the document 74 in information screen 70 and includes highlighted words or phrases 80, 144, 146, 148, 150, 152, 154, and 156 that are hyperlinked to the dictionary module 22 (FIG. 1), along with reference numerals 158, 160, 162, and 164 that are hyperlinked to the references module 32 (FIG. 1). As with the reference numerals 88, the reference numerals 158-164 refer to publications such as articles, research papers, and the like that relate to the subject matter being discussed in the document 142. Although a particular number of highlighted words or phrases and reference numerals have been shown, it is to be understood that the number may vary depending on the length of the document, the number of references cited in the document, and the particular words and phrases used in the document.

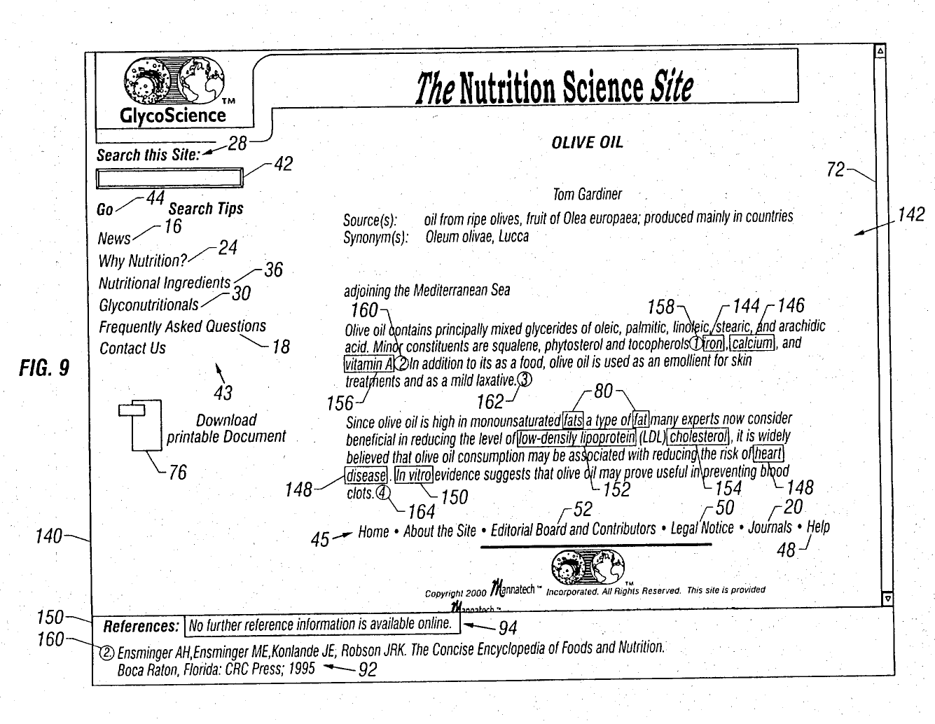

With reference now to FIG. 9, selection of one of the reference numerals 158-164 invokes a window 150 that is displayed with the information screen 140. By way of example, selecting the reference numeral “2” represented by 160 invokes the window 150 which in turn displays the selected reference numeral 160 along with the bibliographic information 92 of the referenced publication and the online availability indicator 94, as previously described. As shown, the referenced publication is not available online. If the referenced publication is available online, the indicator 94 is preferably hyperlinked to a reference information screen 100 (FIG. 5), where the bibliographic information and an abstract of the referenced publication is provided. The full text of the publication can then be accessed and downloaded from the medical information station, as previously described.

With the above-described arrangement, referenced information in any of the documents at the host site 12 can be verified in a quick and efficient manner by linking to publications prepared by disinterested third parties. Consumers and medical professionals are thus able to make informed choices as to which types of products and ingredients are appropriate for obtaining desired health benefits, with confidence that the information provided is current, unbiased, accurate, and based on scholarly research.

While the invention has been taught with specific reference to the above-described embodiments, those skilled in the art will recognize that changes can be made in form and detail without departing from the spirit and the scope of the invention. Thus, the described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The embodiments for which an exclusive property or privilege is claimed are defined as follows:

1. A method for online dissemination of nutritional information, the method comprising:
providing a host station, the host station including at least one document having information relating to the nutritional information and at least one reference citation hyperlinked to at least one publication located at a medical information station, the at least one publication being prepared by a disinterested third party;
connecting to the host station from a remote station;
locating the at least one document; and
hyperlinking to the at least one publication at the medical information station;
whereby information in the at least one document can be verified by reviewing the at least one publication.

2. A system for online dissemination of nutritional information, the system comprising:
a host station;
at least one document located at the host station, the at least one document having information relating to the nutritional information and at least one reference citation;
a medical information station; and
at least one publication located at the medical information station, the at least one citation being hyperlinked to the at least one publication;
whereby information in the at least one document can be verified by hyperlinking to the at least one publication at the medical information station.
